(19) United States
(12) Patent Application Publication
(10) Pub. No.: US 2007/0115579 A1
(43) Pub. Date: May 24, 2007

(54) Method to test a tape drive

(76) Inventor: Khanh Vi Ngo, Tucson, AZ (US)

Correspondence Address: DALE F. REGELMAN, 4231 S. FREMONT AVENUE, TUCSON, AZ, 85714, US

(21) Appl. No.: 11/282,532

(22) Filed: Nov. 18, 2005

(51) Int. Cl. G11B 5/09; G11B 27/36; G11B 15/48

(52) U.S. Cl. 360/53; 360/31; 360/74.1

(57) ABSTRACT

Applicant's invention comprises a method to test a tape drive and its mid-tape recovery abilities. Applicant's method provides a tape drive, and disposes a magnetic tape in that tape drive, wherein the magnetic tape comprises a physical beginning of tape (“PBOT”) and a physical end of tape (“PEOT”). The method writes data from the PBOT to the PEOT, rewinds the tape to the PBOT, and moves the tape from said PBOT toward the PEOT. While the magnetic tape is still moving, the method resets the tape drive. The method then validates the data written to the magnetic tape.

### FIELD OF THE INVENTION

Applicant's invention relates to an apparatus and method to test a tape drive.

### BACKGROUND OF THE INVENTION

Automated media storage libraries are known for providing cost effective access to large quantities of stored media. Generally, media storage libraries include a large number of storage slots on which are stored portable data storage media. The typical portable data storage media comprises a magnetic tape. One (or more) accessors typically accesses a tape cassette from a storage slot and delivers that cassette to a tape drive for reading and/or writing data. Suitable electronics operate the accessor(s) and operate the tape drive to provide information to, and/or to receive information from, an attached on-line host computer system.

What is needed is a method to test a tape drive and its mid-tape recovery abilities, where that tape drive comprises a newly-manufactured unit (as a standalone unit), and/or when that tape drive is installed in an automated media library.

### SUMMARY OF THE INVENTION

Applicant's invention comprises a method to test a tape drive and its mid-tape recovery abilities. Applicant's method provides a tape drive, and disposes a magnetic tape in that tape drive, wherein the magnetic tape comprises a physical beginning of tape (“PBOT”) and a physical end of tape (“PEOT”). The method writes data from the PBOT to the PEOT, rewinds the tape to the PBOT, and moves the tape from said PBOT toward the PEOT. While the magnetic tape is still moving, the method resets the tape drive. The method then validates the tape drive's ability to recover the tape to a ready position and the data written to the magnetic tape.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view of a first embodiment of Applicant's data storage and retrieval system;

FIG. 2 is a perspective view of a second embodiment of Applicant's data storage and retrieval system;

FIG. 3 is a flow chart summarizing the steps of Applicant's method.

### DETAILED DESCRIPTION OF THE PREFERRED EMBODIMENTS

Referring to the illustrations, like numerals correspond to like parts depicted in the figures. The invention will be described as embodied in an automated data storage and retrieval subsystem for use in a data processing environment. The following description of Applicant's method to test a tape drive is not meant, however, to limit Applicant's invention to either data storage and retrieval systems, or to data processing applications, as the invention herein can be applied to testing tape drives in general.

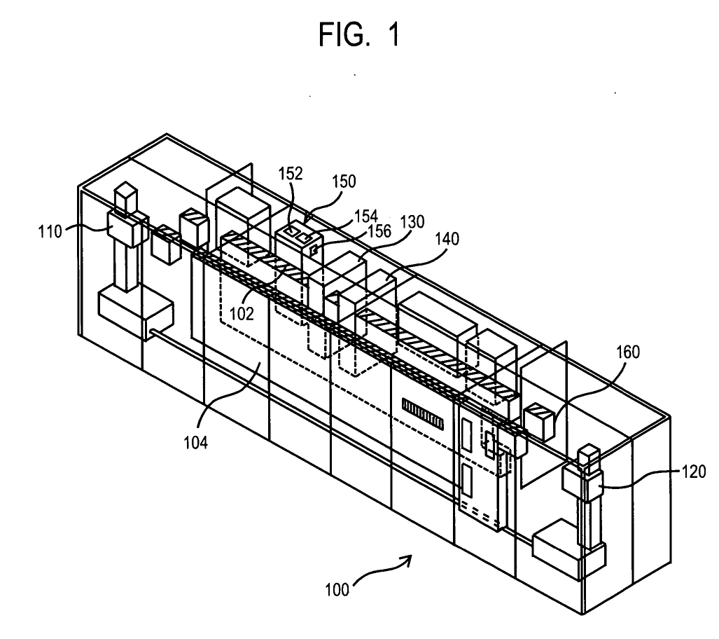

Referring now to FIG. 1, automated data storage and retrieval system 100 is shown having a first wall of storage slots 102 and a second wall of storage slots 104. Portable cassettes each comprising a magnetic tape are individually stored in these storage slots.

Applicant's automated data storage and retrieval system includes one or more accessors, such as accessors 110 and 120. An accessor is a robotic device which accesses portable cassettes from first storage wall 102 or second storage wall 104, transports that accessed cassette to data tape drives 130 or 140 for reading and/or writing data thereon, and returns the media to a proper storage slot.

Library controller 150 comprises a processor 152 and instructions 154 to operate system 100. Power component 160 comprises one or more power supply units which supply power to, inter alia, tape drives 130 and 140.

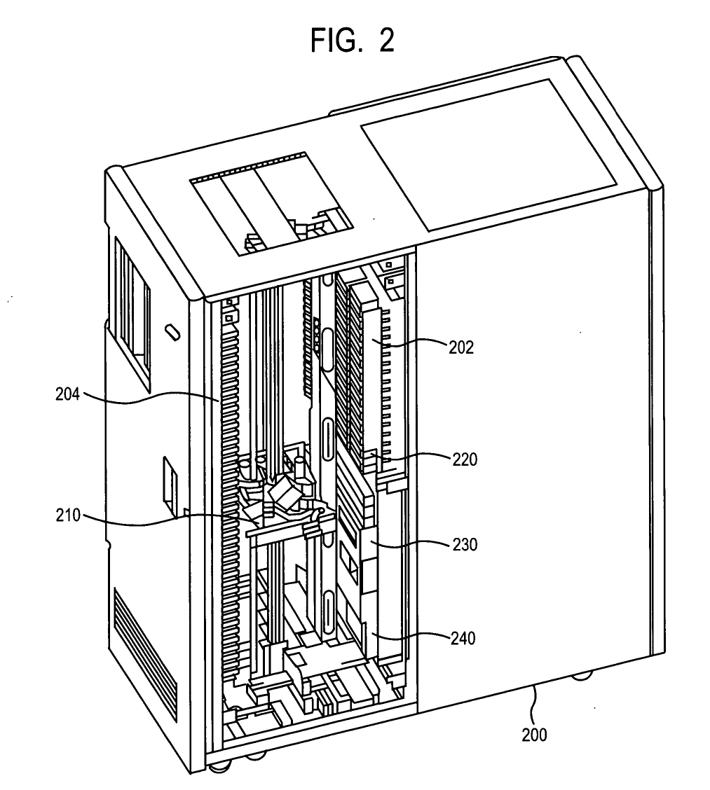

FIG. 2 shows system 200 which comprises another embodiment of Applicant's data storage and retrieval system. System 200 includes first storage wall 202 and second storage wall 204. Storage walls 202 and 204 each include a plurality of storage elements in which can be stored a plurality of portable cassettes 220 each comprising a magnetic tape. System 200 includes tape drive 230. System 200 also includes at least one robotic accessor 210 for transporting a designated portable cassette 220 between a storage slot disposed in first wall 202 or second wall 204 and tape drive 230. Power component 240 supplies power to, inter alia, tape drive 230.

Applicant's invention comprises a method to test a tape drive, such as tape drive 130 (FIG. 1), and/or tape drive 140 (FIG. 1), and/or tape drive 230 (FIG. 2), disposed in an information storage and retrieval system, such as for example system 100 (FIG. 1) or system 200 (FIG. 2). In certain embodiments, Applicant's method comprises testing such tape drive on a regular, on-going basis. In addition, Applicant's method can be used to test newly-manufactured tape drives before those drives are installed in an information storage and retrieval system, such as system 100 or system 200.

Applicant's method tests all the mechanical and electrical functions of such an installed or newly-manufactured tape drive. All data paths to the tape drive are tested. The drive response to one or more LOCATE commands is tested. Servo sensors, tape pickup devices, tape threading mechanisms, are tested. As the tape head disposed in the tape drive is caused to move up and down, various stepper motors disposed in the tape drive are tested.

In addition, Applicant's method power cycles that drive to test the drive's “mid-tape recovery” function, wherein the tape drive is subjected to an unexpected power loss while the tape drive is actively moving a magnetic tape storage medium. As a result of such an unexpected power loss, the tape drive should slowly cause the moving tape to stop moving without damaging the tape or corrupting the data written thereto.

Applicant's method first writes data to a magnetic tape disposed in the tape drive under test, after performing a plurality of test functions, Applicant's method attempts to validate that data. If the data can be validated, then the tape drive functions, including the mid-tape recovery function, have been successfully tested.

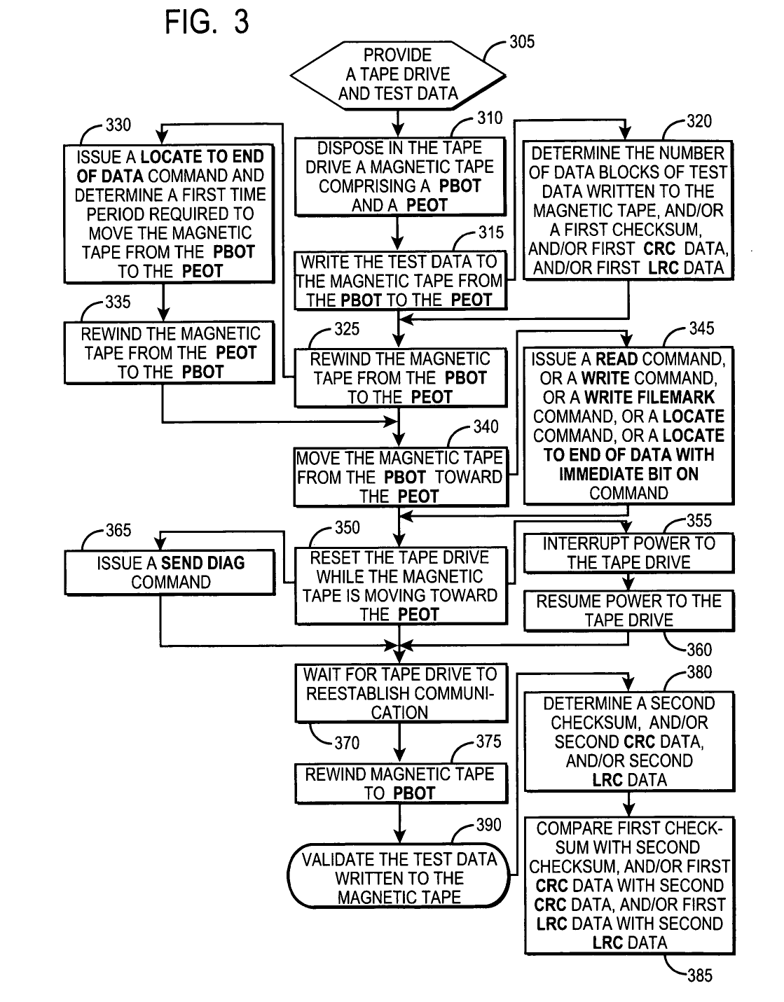

FIG. 3 summarizes the steps of Applicant's method. Referring now to FIG. 3, in step 305 Applicant's method provides a tape drive, such as for example tape drive 130 (FIG. 1), 140 (FIG. 1), 230 (FIG. 2). In certain embodiments, the tape drive of step 305 comprises a newly-manufactured tape drive that has not been installed in a data storage library such as system 100 (FIG. 1) or system 200 (FIG. 2).

In certain embodiments, step 305 further comprises providing test data 156 (FIG. 1). In the illustrated embodiment of FIG. 1, test data 156 is stored in library controller 150.

In step 310, Applicant's method disposes a magnetic tape data storage medium (“magnetic tape”) in the tape drive of step 305, wherein that magnetic tape comprises a physical beginning of tape (“PBOT”) and a physical end of tape (“PEOT”). In certain embodiments, the magnetic tape of step 310 is disposed within a portable cassette housing. In certain embodiments, step 310 is performed by a robotic accessor, such as for example accessor 110 (FIG. 1), accessor 120 (FIG. 1), or accessor 210 (FIG. 2). In other embodiments, step 310 is performed manually.

In step 315, Applicant's method writes, using the tape drive of step 305, data to the magnetic tape of step 310. In certain embodiments, step 315 further comprises writing data from the PBOT to the PEOT. In certain embodiments, step 315 comprises writing the test data of step 305. In certain embodiments, Applicant's method transitions from step 315 to step 325.

In other embodiments, Applicant's method transitions from step 315 to step 320 wherein in certain embodiments the method determines the number blocks of data written in step 315 to the magnetic tape of step 310 using the tape drive of step 305. In certain embodiments, step 320 comprises determining a first checksum for the data written in step 315. In certain embodiments, step 320 comprises determining first cyclic redundancy check (“CRC”) information for the data written in step 315. In certain embodiments, step 320 comprises determining first longitudinal redundancy check (“LRC”) information for the data written in step 315. In certain embodiments, step 320 is performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1).

Applicant's method transitions from step 320 to step 325, wherein the method rewinds the magnetic tape from the PEOT to the PBOT using the tape drive of step 305. In certain embodiments, Applicant's method transitions from step 325 to step 340.

In other embodiments, Applicant's method transitions from step 325 to step 330 wherein the method issues a LOCATE TO END OF DATA command, and wherein the method determines a first time interval comprising the time required to move the magnetic tape from the PBOT to the PEOT. In certain embodiments, step 330 is performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1). Applicant's method transitions from step 330 to step 335 wherein the method rewinds the magnetic tape from the PEOT to the PBOT using the tape drive of step 305.

Applicant's method transitions from step 335 to step 340 wherein the method moves the magnetic tape from the PBOT toward the PEOT. In certain embodiments, Applicant's method transitions from step 340 to step 350. In certain embodiments, step 340 comprises issuing a command that can return good status prior to the command completing, thereby returning control of the tape drive to a library controller before completing these commands, which is the objective. In certain embodiments, step 340 comprises issuing a READ command of step 345. In certain embodiments, step 340 comprises issuing a WRITE command of step 345. In certain embodiments, step 340 comprises issuing a WRITE FILEMARK command of step 345. In certain embodiments, step 340 comprises issuing a ERASE command of step 345. In certain embodiments, step 340 comprises issuing a LOCATE command of step 345.

In certain embodiments, step 340 comprises issuing a LOCATE TO END OF DATA WITH IMMEDIATE BIT ON command of step 345. Such a LOCATE TO END OF DATA WITH IMMEDIATE BIT ON command returns a good status immediately, and prior to completing the command, thereby returning control of the tape drive to a library controller before completing the LOCATE command.

Applicant's method transitions from step 345 to step 350 wherein the method resets the tape drive while the magnetic tape is moving from the PBOT to the PEOT. Such a tape drive reset mimics an unexpected power loss to the tape drive while that drive is moving the magnetic tape. As described above, the tape drive should automatically execute a graceful braking algorithm on the tape media whereunder the movement of the magnetic tape is slowly stopped without damaging the magnetic tape or corrupting the data written thereto. To ensure that the magnetic tape is still moving at the time of tape drive reset, in certain embodiments step 350 comprises determining a second time interval commencing from the implementation of step 340 and ending with the tape drive reset of step 350, such that the second time interval is less than the first time interval of step 330. In certain embodiments, step 350 is performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1). In certain embodiments, Applicant's method transitions from step 350 to step 370.

In certain embodiments, step 350 comprises step 355 wherein the reset of step 350 comprises interrupting the power from a power source, such as power source 160 (FIG. 1), to the tape drive. Applicant's method transitions from step 355 to step 360 wherein the method restores the power to the tape drive. In certain embodiments, steps 355 and 360 are performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1). Applicant's method transitions from step 360 to step 370.

In certain embodiments, step 350 comprises step 365 wherein the method issues a SEND DIAG command for Self-Test to the tape drive causing the tape drive to reset. In certain embodiments, step 365 is performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1). Applicant's method transitions from step 365 to step 370.

In step 370, Applicant's method waits for the tape drive to reestablish communication. In certain embodiments, step 370 comprises waiting for the tape drive to reestablish communication with a controller, such as controller 150 (FIG. 1), disposed in a data storage and retrieval system, such as system 100 (FIG. 1), comprising the tape drive, such as tape drive 130 (FIG. 1) or tape drive 140 (FIG. 1).

Applicant's method transitions from step 370 to step 375 wherein the method rewinds the magnetic tape to the PBOT. In certain embodiments, step 375 comprises part of the tape drive's mid-tape recovery algorithm.

Applicant's method transitions from step 375 to step 390 wherein the method validates the test data written to the tape in step 315. In certain embodiments, step 390 comprises step 380 wherein the method determines a second checksum for the data written to the magnetic tape. In certain embodiments, step 390 comprises step 380 wherein the method determines second CRC information for the data written to the magnetic tape. In certain embodiments, step 390 comprises step 380 wherein the method determines a second LRC information for the data written to the magnetic tape. In certain embodiments, step 380 is performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1). Applicant's method transitions from step 365 to step 370.

Applicant's method transitions from step 380 to step 385 wherein in certain embodiments, Applicant's method compares a first checksum of step 320 with a second checksum of step 380 to validate the data written to the magnetic tape. In certain embodiments, step 385 comprises comparing first CRC information of step 320 with second CRC information of step 380 to validate the data written to the magnetic tape. In certain embodiments, step 385 comprises comparing first LRC information of step 320 with second LRC information of step 380 to validate the data written to the magnetic tape. In certain embodiments, step 385 is performed by a controller, such as controller 150 (FIG. 1), disposed in a data storage and retrieval system, such as system 100 (FIG. 1), comprising the tape drive, such as tape drive 130 (FIG. 1) or tape drive 140 (FIG. 1). Applicant's method transitions from step 365 to step 370.

If Applicant's method can validate the data written to the magnetic tape in step 390, then the tape drive of step 305 has passed Applicant's test method of FIG. 3. On the other hand, if Applicant's method cannot validate the data written to the magnetic tape in step 390, then the tape drive of step 305 did not pass Applicant's test method of FIG. 3.

In certain embodiments, the individual steps of FIG. 3 can be combined, reordered, or eliminated. For example, in certain embodiments, Applicant's method comprises steps 305, 310, 315, 325, 340, 350, 370, and 390. In other embodiments, Applicant's method comprises steps 305, 310, 315, 325, 330, 335, 340, 350, 370, and 390. In other embodiments, Applicant's method comprises steps 305, 310, 315, 325, 330, 335, 340, 345, 350, 370, and 390. In other embodiments, Applicant's method comprises steps 305, 310, 315, 325, 330, 335, 340, 345, 350, 365, 370, and 390. In other embodiments, Applicant's method comprises steps 305, 310, 315, 325, 330, 335, 340, 345, 350, 355, 360, 370, and 390. In other embodiments, Applicant's method comprises steps 305, 310, 315, 325, 330, 335, 340, 345, 350, 365, 370, 380, 385, and 390.

Applicant's invention includes instructions residing in a computer program product, where those instructions are executed by a computer external to, or internal to, system 100 (FIG. 1) and/or system 200 (FIG. 2), to perform steps one or more of steps 310, 315, 320, 325, 330, 335, 340, 345, 350, 355, 360, 365, 370, 380, 385, and/or 390, recited in FIG. 3. Such instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to test a tape drive, comprising the steps of:
providing a tape drive and a magnetic tape, wherein said magnetic tape comprises a physical beginning of tape (“PBOT”) and a physical end of tape (“PEOT”);
disposing said magnetic tape in said tape drive;
writing data from said PBOT to said PEOT;
rewinding said tape to said PBOT;
moving said tape from said PBOT toward said PEOT;
resetting said tape drive while said magnetic tape is moving toward said PEOT;
validating said data written to said magnetic tape.

2. The method of claim 1, further comprising the following steps after said rewinding step and before said moving step:
issuing a LOCATE TO END OF DATA command which causes said tape drive to move said magnetic tape from said PBOT to said PEOT;
determining a first time period comprising the time required to move said magnetic tape from said PBOT to said PEOT;
returning said magnetic tape from said PEOT to said PBOT.

3. The method of claim 2, wherein:
said moving step further comprises beginning a second time period;
said resetting step further comprises ending said second time period, such that said second time period is less than said first time period.

4. The method of claim 1, wherein said moving step further comprises issuing a READ command.

5. The method of claim 1, wherein said moving step further comprises issuing a WRITE command.

6. The method of claim 1, wherein said moving step further comprises issuing a LOCATE TO END OF DATA WITH THE IMMEDIATE BIT ON.

7. The method of claim 1, wherein said resetting step further comprises issuing a SEND DIAG command.

8. The method of claim 1, wherein said resetting step further comprises interrupting the power to said tape drive.

9. The method of claim 8, further comprising the step of restoring power to said tape drive after said interrupting power step and before said validating data step.

10. The method of claim 9, further comprising the step of rewinding said magnetic tape to said PBOT after said restoring power step and before said validating data step.

11. A computer program product usable with a programmable computer processor having computer readable program code embodied therein to test a tape drive, comprising:
computer readable program code which causes said programmable computer processor to dispose a magnetic tape in a tape drive, wherein said magnetic tape comprises a physical beginning of tape (“PBOT”) and a physical end of tape (“PEOT”);
computer readable program code which causes said programmable computer processor to write test data from said PBOT to said PEOT;
computer readable program code which causes said programmable computer processor to rewind said magnetic tape to said PBOT;
computer readable program code which causes said programmable computer processor to move said tape from said PBOT toward said PEOT;
computer readable program code which causes said programmable computer processor to reset said tape drive while said magnetic tape is moving toward said PEOT;
computer readable program code which causes said programmable computer processor to validate said data written to said magnetic tape.

12. The computer program product of claim 11, further comprising:
computer readable program code which causes said programmable computer processor to issue a LOCATE TO END OF DATA command after rewinding said magnetic tape;
computer readable program code which causes said programmable computer processor to determine a first time period comprising the time required to advance said magnetic tape from said PBOT to said PEOT while executing said LOCATE TO END OF DATA command.

13. The computer program product of claim 12, wherein:
said computer readable program code which causes said programmable computer processor to move said magnetic tape further comprises computer readable program code which causes said programmable computer processor to begin a second time period;
said computer readable program code which causes said programmable computer processor to said reset said tape drive further comprises computer readable program code which causes said programmable computer processor to end said second time period such that said second time period is less than said first time period.

14. The computer program product of claim 11, wherein said computer readable program code which causes said programmable computer processor to move said magnetic tape from said PBOT to said PEOT further comprises computer readable program code which causes said programmable computer processor to issue a READ command.

15. The computer program product of claim 11, wherein said computer readable program code which causes said programmable computer processor to move said magnetic tape from said PBOT to said PEOT further comprises computer readable program code which causes said programmable computer processor to issue a WRITE command.

16. The computer program product of claim 11, wherein said computer readable program code which causes said programmable computer processor to move said magnetic tape from said PBOT to said PEOT further comprises computer readable program code which causes said programmable computer processor to issue a LOCATE TO END OF DATA WITH THE IMMEDIATE BIT ON.

17. The computer program product of claim 11, wherein said computer readable program code which causes said programmable computer processor to reset said tape drive further comprises computer readable program code which causes said programmable computer processor to issue a SEND DIAG command.

18. The computer program product of claim 11, wherein said computer readable program code which causes said programmable computer processor to reset said tape drive further comprises computer readable program code which causes said programmable computer processor to interrupt the power to said tape drive.

19. The computer program product of claim 18, further comprising computer readable program code which causes said programmable computer processor to restore power to said tape drive after interrupting the power to said tape drive and before validating said data.

20. The computer program product of claim 19, further comprising computer readable program code which causes said programmable computer processor to rewind said magnetic tape to said PBOT after restoring power to said tape drive and before validating said data.
